(19) United States
(12) Patent Application Publication
(10) Pub. No.: US 2012/0162248 A1
(43) Pub. Date: Jun. 28, 2012

(54) Method for Eliminating a Cockpit Mask and Associated Helmet-Mounted Display System

(75) Inventors: Jean-Michel FRANCOIS, Cadaujac (FR); Matthieu GROSSETETE, Bordeaux (FR); Laurent LALUQUE, Bordeaux (FR)

(73) Assignee: THALES, Neuilly-sur-Seine (FR)

(21) Appl. No.: 13/331,743

(22) Filed: Dec. 20, 2011

(30) Foreign Application Priority Data
Dec. 23, 2010 (FR) 10 05075

(51) Int. Cl. G09G 5/00

(52) U.S. Cl. 345/620; 345/8

(57) ABSTRACT

The general field of the invention relates to the binocular helmet-mounted display devices worn by aircraft pilots. In night use, one of the drawbacks of this type of device is that the uprights of the cockpit introduce significant visual masks into the field of the optical sensors. The method according to the invention is a method for eliminating these masks in the images presented to the pilot by graphics processing of the binocular images. It relies on the fact that, given the parallax, the uprights occupy, in two images from the left and right sensors, different positions. The comparison of the two images makes it possible to identify, and then eliminate, these masks, and finally to replace them with parts of images of the outside landscape.

### CROSS-REFERENCE TO RELATED APPLICATION

This application claims priority to foreign French patent application No. FR 1005075, filed on Dec. 23, 2010, the disclosure of which is incorporated by reference in its entirety.

### FIELD OF THE INVENTION

The field of the invention is that of the helmet-mounted display that include low-light-level display devices used in aircraft cockpits. The invention applies more particularly to the helicopters used in night missions.

### BACKGROUND

A system of this type is represented in FIG. 1 in a functional situation worn on the head of a pilot in a helicopter cockpit. FIG. 1 is a plan view. It schematically includes the limits L of the cockpit, an upright of the cockpit M in the form of a hoop, the head of the pilot P and his display helmet C. The head P has two circles Y representative of the positions of the eyes. The shell of the helmet includes two sensors C_{BNL} (BNL standing for “Bas Niveau de Lumiére”, which means “low light level”) making it possible to produce an intensified image of the outside landscape. These sensors are positioned on each side of the helmet as can be seen in FIG. 1. Each sensor has an associated helmet-mounted display HMD. The two helmet-mounted displays give two images to infinity of the intensified images. The collimation is generally handled by the visor of the helmet. These two collimated images are perceived by the eyes of the pilot. These two images have a unitary enlargement so as to be best overlaid on the outside landscape.

As can be seen in FIG. 1, the upright M of the cockpit is hoop-shaped and is inevitably in the field θ_{CBNL} of the two sensors C_{BNL}. These fields are shown by dotted lines in FIG. 1. It introduces, given the sensitivity specifics of the BNL sensors, a black or very dark visual mask in each image which is, obviously, restored in the helmet-mounted displays. Thus, as can be seen in FIG. 2 which shows the views of the outside landscape perceived respectively by the right eye and the left eye of the pilot through the helmet-mounted displays, the pilot has a portion of his visual field obliterated by the mask of the upright.

This masking effect hampers the pilot in his piloting and in particular in certain flight phases. This effect is all the stronger because of the often very dark appearance of the uprights. This problem can be minimized, or even cancelled out depending on the cockpit, by modifying, from design, the placement of the BNL sensors used to capture night images. This solution involves significant design constraints and also implies designing a specific helmet adapted to a particular wearer. It is also possible to move the sensors outside the cockpit. This results in a nonconforming viewpoint modifying the perception of the environment. Also, these sensors must be slaved to the position of the head of the pilot.

This problem is currently preferentially left to the responsibility of the pilot who makes regular head movements to obtain the information masked by the cabin, thus greatly increasing his workload to the detriment of his availability, often referred to by the term “situation awareness”.

### SUMMARY OF THE INVENTION

The method according to the invention makes it possible to solve this problem. The method is based on the use of the redundancy of information provided by the binocularity of the right and left BNL sensors of the helmet. In the BNL images, the visual mask of the uprights is replaced by a virtual representation adopting a suitable symbology of the “cockpit transparent” type and the outside scene information useful to the piloting is added thereto.

More specifically, the subject of the invention is a method for eliminating a cockpit mask in a helmet-mounted display device worn by a pilot, said pilot placed in an aircraft cockpit that includes at least one upright placed in the visual field of the pilot, the display device comprising: a first binocular assembly of image sensors capable of operating at low light levels and delivering a first intensified image and a second intensified image, each of said intensified images comprising an image of said upright overlaid on an image of the outside landscape; a second binocular helmet-mounted display assembly arranged so as to present to the pilot the first intensified image and the second intensified image; an image-processing graphics computer. It is characterized in that the method for eliminating the cockpit mask is implemented by the graphics computer and comprises the following steps: Step 1: Creation of a map of the disparities that exist between the first intensified image and the second intensified image with which to identify the elements of the upright that constitute the mask; Step 2: Fine trimming of the elements of the upright constituting the mask by extraction of contours in each of the two intensified images; Step 3: Elimination of said elements in the first image and replacement by the corresponding parts of the outside landscape found in the second image and elimination of said elements in the second image and replacement by the corresponding parts of the outside landscape found in the first image; Step 4: Presentation of the first intensified image processed without mask and of the second image processed without mask in the second binocular helmet-mounted display assembly.

Advantageously, since the parts of the outside landscape that are not masked either in the first intensified image or in the second intensified image are redundant, said parts are presented, in the step 4, with an enhanced resolution taking into account this redundancy.

Advantageously, when the helmet comprises a device for detecting the posture of the head of the pilot, the step 1 is preceded by a step 0 in which the approximate position of the elements of the upright in the first and in the second intensified images are predetermined.

Advantageously, the elements of the upright are equipped with passive or active optical markers that can be identified during the step 1 by the graphics computer.

Advantageously, each image being made up of pixels, in the step 3, the replacements of the elements of the mask by the corresponding parts of the outside landscape in the intensified images is performed by bilinear interpolation of the corresponding pixels of each image.

Advantageously, the step 3 is preceded by a step 2a in which the graphics computer searches, in the areas adjacent to the elements of the upright, for the points or areas of interest.

Advantageously, the step 3 is followed by a step 3a in which a common synthetic image is overlaid on the processed first intensified image and on the processed second intensified image.

Advantageously, the synthetic image comprises a stylized representation of the elements of the upright, said representation being situated approximately in the positions of the elements of the real upright.

Advantageously, the synthetic image comprises a conventional piloting symbology.

The invention also relates to the helmet-mounted display device associated with the method described above and comprising: a first binocular assembly of image sensors capable of operating at low light levels and delivering a first intensified image and a second intensified image, a second binocular helmet-mounted display assembly arranged so as to present to the pilot the first intensified image and the second intensified image; an image-processing graphics computer which comprises electronic and computing means arranged so as to implement the method for eliminating a cockpit mask.

### BRIEF DESCRIPTION OF THE DRAWINGS

The invention will be better understood and other advantages will become apparent from reading the following description given as a nonlimiting example and by virtue of the appended figures in which:

FIG. 1, already described, represents a helmet-mounted display device in its environment;

FIG. 2 represents the intensified images seen by the two sensors before processing;

FIG. 3 represents the same images after processing and elimination of the mask due to the upright;

FIGS. 4, 5 and 6 represent an image after processing including different stylized representations of the elements of the upright;

FIG. 7 represents an image after processing including a conventional piloting symbology.

### DETAILED DESCRIPTION

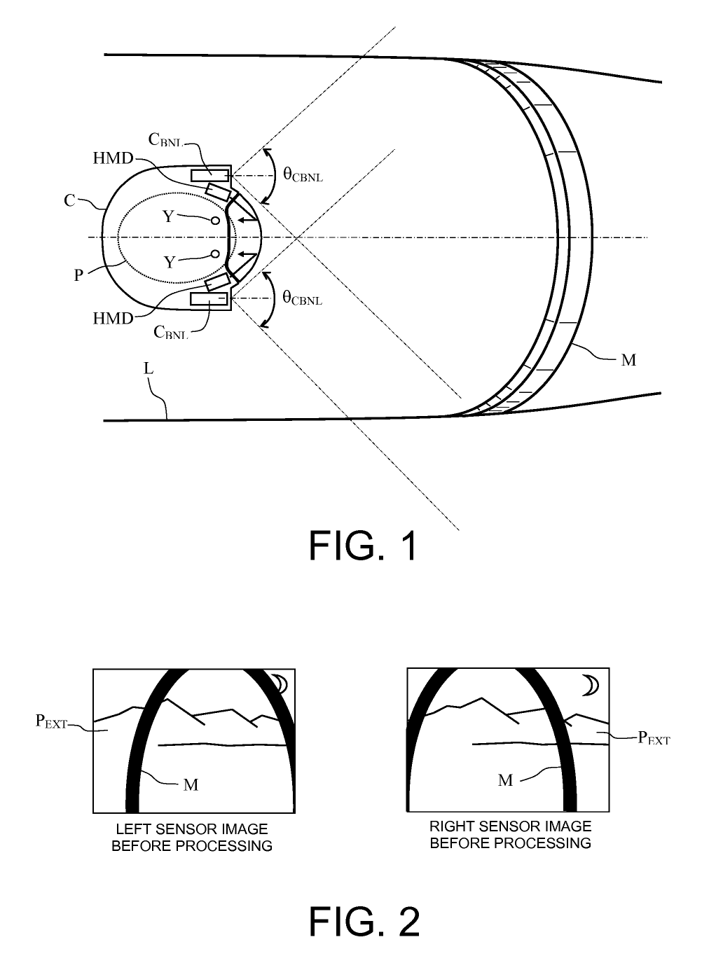

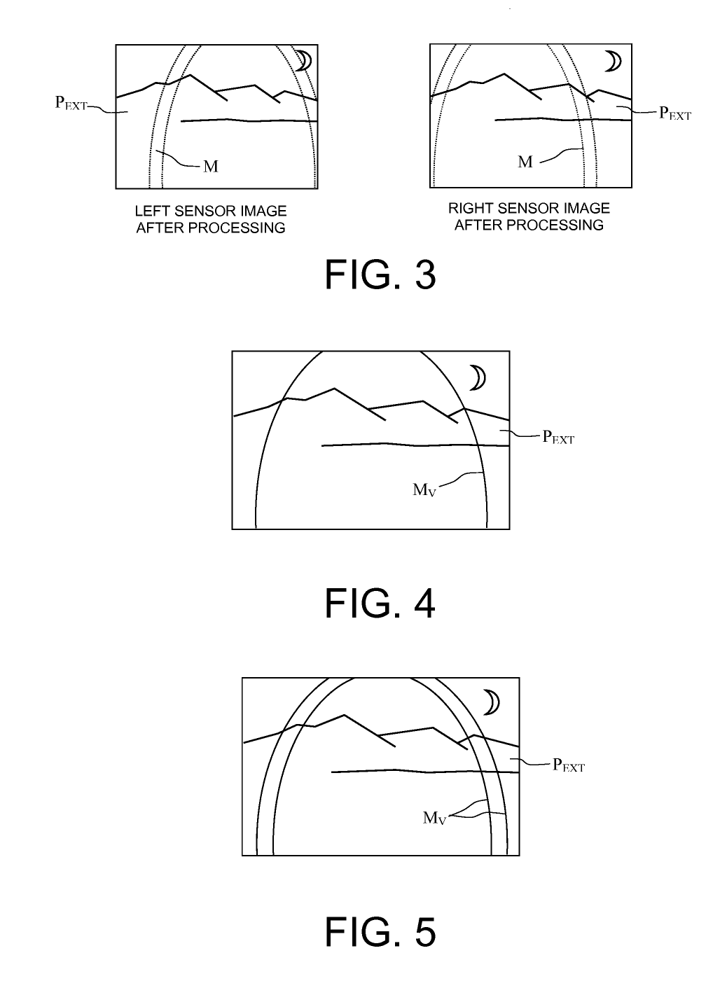

FIG. 2 schematically represents the images perceived by the left and right BNL sensors of a display device as represented in FIG. 1. These images are called LEFT SENSOR IMAGE BEFORE PROCESSING and RIGHT SENSOR IMAGE BEFORE PROCESSING in this FIG. 2. These images include a mountain landscape P_{EXT} illuminated by the moon and a black hoop M representing the uprights of the cockpit. Since the landscape is in the distance, it occupies the same position in both left and right images, the nearer objects being able to have a certain parallax between the left and right images. On the other hand, as can be seen in FIG. 2, the upright M necessarily being close to the pilot, it does not occupy the same position in the left and right images given the parallax that exists between the left and right BNL sensors. Thus, the parts of the landscape that are masked by the upright and that do not appear on the image from the left sensor appear on the image from the right sensor and vice versa. If the information from the two images is aggregated, it is possible to eliminate the mask introduced by the upright and restore a processed image showing all of the landscape. FIG. 3 illustrates this method. The processed images called LEFT SENSOR IMAGE AFTER PROCESSING and RIGHT SENSOR IMAGE AFTER PROCESSING no longer include uprights. The initial positions of the upright M are simply indicated by dotted lines in the left and right images.

The method according to the invention relies on this principle. More specifically, the method for eliminating the cockpit mask is implemented by the graphics computer and comprises the following four main steps:

Step 1: Creation of a map of the disparities that exist between the first intensified image and the second intensified image coming from the left and right BNL sensors to identify the elements of the upright that constitute the mask;

Step 2: Fine trimming of the elements of the upright constituting the mask by extraction of contours in each of the two intensified images;

Step 3: Elimination of said elements in the first image and replacement by the corresponding parts of the outside landscape found in the second image and elimination of said elements in the second image and replacement by the corresponding parts of the outside landscape found in the first image;

Step 4: Presentation of the first intensified image processed without mask and of the second image processed without mask in the second binocular helmet-mounted display assembly.

When the helmet comprises a device for detecting the posture of the head of the pilot, or “DDP”, the step 1 may be preceded by a pre-step in which the approximate position of the elements of the upright are predetermined in the first and in the second intensified images. The searching time and therefore the latency are thus reduced. It is also possible to use this predetermination to check the integrity of the results obtained in the following steps of the method.

The elements of the upright may be equipped with passive or active optical markers that can be identified during the step 1 by the graphics computer. The active sensors may be diodes emitting, for example, in an infrared spectral range invisible to the pilot and situated in the detection band of the sensors.

The identification of the elements of the cabin mask may be made roughly by the creation of a map of the disparities that exist between the two images. It is also possible to identify the masking elements of the cockpit by more complex methods of dense interpolation of movements between the two sensors. These methods are known to those skilled in the art.

During the step 2, the graphics methods used to implement a fine trimming of the elements of the upright may be filtering or “binarization” methods well known in the field of graphics image processing.

During the step 3, the graphics computer may search, in a first image and in the areas adjacent to the elements of the upright, for points or areas of interest corresponding to the “expected” area of the second image. Different techniques can be used. These include:
area matching methods of “Block Matching” type;
methods based on searching and “matching” points of interest with the descriptors adapted to the shape of the upright sought.

So as to smooth the artefacts caused by this inlaying between images, a merging mask, created from the fine trimming elements of the uprights of the step 2 and giving suitable respective weights to each image, can be used.

Knowing precisely the positioning and the optical parameters of the two sensors, such as the position of their optical axes, the distortion of the optics and the separation of the optical axes, in step 3, still by the use of a specific graphics computer, the filling in of the parts of images of the channels masked by the uprights is carried out. In this step, if a greater processing speed is desired, it is possible to use only the model of the system of sensors, previously calibrated, to simply recompute, dot-by-dot, the missing pixels in the two images by bilinear interpolation of the associated pixels of the image of the other channel.

Since the parts of the outside landscape that are not masked either in the first intensified image or in the second intensified image are redundant, said parts can be presented, in the step 3, with an enhanced resolution taking into account this redundancy. It is possible, for example, to average the levels of the pixels of each image by taking into account the levels of the corresponding pixels in the other image, thus lowering the noise level. More sophisticated processing operations are also possible.

The step 3 can be followed by a step 3a in which a common synthetic image is overlaid on the processed first intensified image and on the processed second intensified image.

This synthetic image offers a number of benefits. It is known that the cabin uprights represent a masking of the outside landscape, but that they also serve as marker for the pilot for determining the attitude of the aircraft. It is therefore advantageous to reintroduce them in the form of virtual markers approximately in the positions of the elements of the real upright.

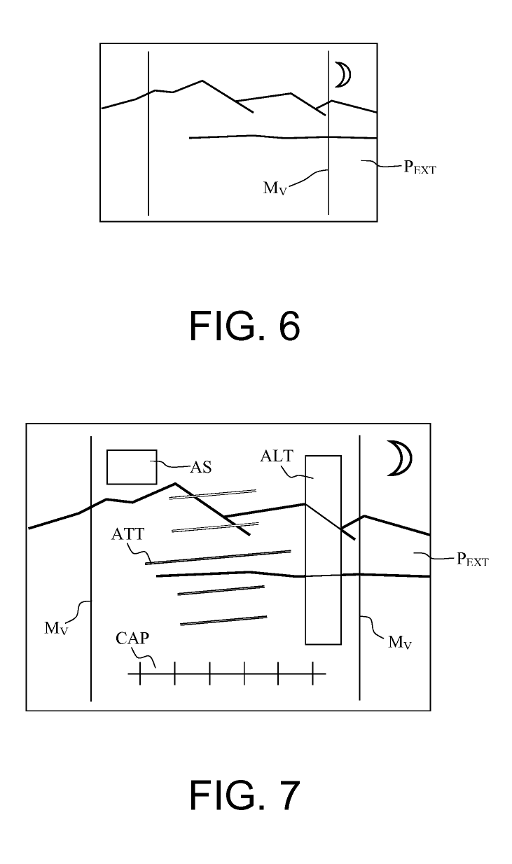

FIGS. 4, 5 and 6 represent three possible examples of this reintroduction. In FIG. 4, the virtual uprights M_{V} are hoop-shaped like the real uprights but, so as to minimize the visual masks, this hoop comprises a single hoop of small thickness. In FIG. 5, this hoop is doubled so as to simulate the thickness of the uprights. In FIG. 6, the uprights M_{V} are represented by two straight vertical lines.

There is, obviously, an interest in having the synthetic image include all or some of the information necessary to the piloting. Thus, for example, in FIG. 7, the synthetic image includes an indication of the speed of the aircraft AS, of its attitude ATT, of its altitude ALT and of its heading CAP.

The method according to the invention thus makes it possible to reduce the workload of the pilot while allowing for the design of a multiwearer helmet since the work of minimizing, even of eliminating depending on the cockpit, the cabin mask is performed by a specific graphics computer which requires no modification of any of the optical, mechanical or electronic parts of the helmet-mounted display device, since only the digital image-processing software is specific.

As has been stated, the preferred field of application is that of the “unmasking” of the uprights of aircraft cockpit for presentation on the helmet-mounted display devices, but other applications are possible. These include, for example, image correction for 3D cameras in the context of photo or video applications.

1. A method for eliminating a cockpit mask in a helmet-mounted display device worn by a pilot, the helmet comprising a device for detecting the posture of the head of the pilot, said pilot placed in an aircraft cockpit that includes at least one upright placed in the visual field of the pilot, the display device comprising a first binocular assembly of image sensors capable of operating at low light levels and delivering a first intensified image and a second intensified image, each of said intensified images comprising an image of said upright overlaid on an image of the outside landscape; a second binocular helmet-mounted display assembly arranged so as to present to the pilot the first intensified image and the second intensified image; and an image-processing graphics computer; the method for eliminating the cockpit mask being implemented by the graphics computer and comprising the following steps:
step 0) predetermination of the approximate position of the elements of the upright in the first and in the second intensified images;
step 1) creation of a map of the disparities that exist between the first intensified image and the second intensified image to identify the elements of the upright those constitute the mask;
step 2) fine trimming of the elements of the upright constituting the mask by extraction of contours in each of the two intensified images;
step 3) elimination of said elements in the first image and replacement by the corresponding parts of the outside landscape found in the second image and elimination of said elements in the second image and replacement by the corresponding parts of the outside landscape found in the first image;
step 4) presentation of the first intensified image processed without mask and of the second image processed without mask in the second binocular helmet-mounted display assembly.

2. A method for eliminating a cockpit mask according to claim 1, wherein, since the parts of the outside landscape that are not masked either in the first intensified image or in the second intensified image are redundant, said parts are presented, in step 4, with an enhanced resolution taking into account this redundancy.

3. A method for eliminating a cockpit mask according to claim 1, wherein the elements of the upright are equipped with passive or active optical markers that can be identified during step 1 by the graphics computer.

4. A method for eliminating a cockpit mask according to claim 1, wherein, each image being made up of pixels, in step 3, the replacements of the elements of the mask by the corresponding parts of the outside landscape in the intensified images is performed by bilinear interpolation of the corresponding pixels of each image.

5. A method for eliminating a cockpit mask according to claim 1, wherein step 3 is preceded by a step in which the graphics computer searches, in the areas adjacent to the elements of the upright, for the points or areas of interest.

6. A method for eliminating a cockpit mask according to claim 1, wherein step 3 is followed by a step in which a common synthetic image is overlaid on the processed first intensified image and on the processed second intensified image.

7. A method for eliminating a cockpit mask according to claim 6, wherein the synthetic image comprises a stylized representation of the elements of the upright, said representation being situated approximately in the positions of the elements of the real upright.

8. A method for eliminating a cockpit mask according to claim 6, wherein the synthetic image comprises a conventional piloting symbology.

9. A helmet-mounted display device comprising:
a first binocular assembly of image sensors (C_{BNL}) capable of operating at low light levels and delivering a first intensified image and a second intensified image,
a second binocular helmet-mounted display (HMD) assembly arranged so as to present to the pilot the first intensified image and the second intensified image; and
an image-processing graphics computer;
wherein the computer comprises electronic and computing means arranged so as to implement the method for eliminating a cockpit mask according to claim 1.

10. A helmet-mounted display device comprising:
a first binocular assembly of image sensors (C_{BNL}) capable of operating at low light levels and delivering a first intensified image and a second intensified image,
a second binocular helmet-mounted display (HMD) assembly arranged so as to present to the pilot the first intensified image and the second intensified image; and
an image-processing graphics computer;
wherein the computer comprises electronic and computing means arranged so as to implement the method for eliminating a cockpit mask according to claim 2.

11. A helmet-mounted display device comprising:
a first binocular assembly of image sensors (C_{BNL}) capable of operating at low light levels and delivering a first intensified image and a second intensified image,
a second binocular helmet-mounted display (HMD) assembly arranged so as to present to the pilot the first intensified image and the second intensified image; and
an image-processing graphics computer;
wherein the computer comprises electronic and computing means arranged so as to implement the method for eliminating a cockpit mask according to claim 3.

12. A helmet-mounted display device comprising:
a first binocular assembly of image sensors (C_{BNL}) capable of operating at low light levels and delivering a first intensified image and a second intensified image,
a second binocular helmet-mounted display (HMD) assembly arranged so as to present to the pilot the first intensified image and the second intensified image; and
an image-processing graphics computer;
wherein the computer comprises electronic and computing means arranged so as to implement the method for eliminating a cockpit mask according to claim 4.

13. A helmet-mounted display device comprising:
a first binocular assembly of image sensors (C_{BNL}) capable of operating at low light levels and delivering a first intensified image and a second intensified image,
a second binocular helmet-mounted display (HMD) assembly arranged so as to present to the pilot the first intensified image and the second intensified image; and
an image-processing graphics computer;
wherein the computer comprises electronic and computing means arranged so as to implement the method for eliminating a cockpit mask according to claim 5.

14. A helmet-mounted display device comprising:
a first binocular assembly of image sensors (C_{BNL}) capable of operating at low light levels and delivering a first intensified image and a second intensified image,
a second binocular helmet-mounted display (HMD) assembly arranged so as to present to the pilot the first intensified image and the second intensified image; and
an image-processing graphics computer;
wherein the computer comprises electronic and computing means arranged so as to implement the method for eliminating a cockpit mask according to claim 6.

15. A helmet-mounted display device comprising:
a first binocular assembly of image sensors (C_{BNL}) capable of operating at low light levels and delivering a first intensified image and a second intensified image,
a second binocular helmet-mounted display (HMD) assembly arranged so as to present to the pilot the first intensified image and the second intensified image; and
an image-processing graphics computer;
wherein the computer comprises electronic and computing means arranged so as to implement the method for eliminating a cockpit mask according to claim 7.

16. A helmet-mounted display device comprising:
a first binocular assembly of image sensors (C_{BNL}) capable of operating at low light levels and delivering a first intensified image and a second intensified image,
a second binocular helmet-mounted display (HMD) assembly arranged so as to present to the pilot the first intensified image and the second intensified image; and
an image-processing graphics computer;
wherein the computer comprises electronic and computing means arranged so as to implement the method for eliminating a cockpit mask according to claim 8.

17. A helmet-mounted display device comprising:
a first binocular assembly of image sensors (C_{BNL}) capable of operating at low light levels and delivering a first intensified image and a second intensified image,
a second binocular helmet-mounted display (HMD) assembly arranged so as to present to the pilot the first intensified image and the second intensified image; and
an image-processing graphics computer;
wherein the computer comprises electronic and computing means arranged so as to implement the method for eliminating a cockpit mask according to claim 9.
